(19) United States
(12) Patent Application Publication
(10) Pub. No.: US 2025/0264262 A1
(43) Pub. Date: Aug. 21, 2025

(54) ACTIVE INSULATED CONTAINER

(71) Applicant: Dometic Sweden AB, Solna (SE)

(72) Inventors: Ralf Richter, Farmington Hills, MI (US); David Kueterman, Monroe, MI (US); Stephen Searl, Goshen, IN (US)

(21) Appl. No.: 19/058,996

(22) Filed: Feb. 20, 2025

Related U.S. Application Data
(60) Provisional application No. 63/556,074, filed on Feb. 21, 2024.

(51) Int. Cl. F25D 11/00; B60N 3/10; F25D 17/06; F25D 23/02

(52) U.S. Cl. CPC F25D 11/003; B60N 3/104; F25D 17/06; F25D 23/026

(57) ABSTRACT

Present embodiments relate to an active insulated container which may be used in a vehicle. More specifically, but without limitation, present embodiments relate to active insulated containers which may be mounted in a vehicle and which creates a positive pressure upon entry of water into one or more ducts to preclude entrance of water into a thermal engine enclosure housing the thermal engine, even when mounted at a lower elevation of the vehicle.

### INCORPORATION BY REFERENCE

Any and all applications for which a foreign or domestic priority claim is identified in the Application Data Sheet as filed with the present application are hereby incorporated by reference herein and made a part of the present disclosure.

### BACKGROUND

### 1. Field of the Invention

Present embodiments relate to active insulated containers which may be used in a vehicle. More specifically, but without limitation, present embodiments relate to active insulated containers which may be mounted in a vehicle and which preclude entrance of water into the area of the thermal engine, even when mounted at a lower elevation of the vehicle.

### 2. Description of the Related Art

Vehicles have a fording depth, which is a level or depth of water through which a vehicle can pass without experiencing functional damage. The upper elevation of this fording depth may also be referred to as the fording line.

One feature which has become more desirable in vehicles is a temperature controlled (cooled and/or heated) compartment, or climate controlled bin, for storage of food, drink, or other temperature sensitive items which may provide refrigeration, freezing, or heating for the goods. The active insulated container may comprise a thermal engine which provides the cooling, or heat removal, so that the food and drink may be stored and maintained safely. In some embodiments, the insulated container may be used to provide heat and for contents that need to stay warm. These systems are convenient because they may be powered by the vehicle and do not require the user to add ice or heat source to the container.

However, as space is at a premium in many vehicles, new places are located for these active insulated containers. In some vehicles it may be desirable to locate such container at a location below a fording line or, or within, the fording depth. However, when water is higher than the fording line, water entrance into this area may result in damage to the components of the active insulated container. In other words, when the active insulated container is at a level below the fording line and when water enters the area, the active cooling or heating components may be susceptible to the water intrusion and damage therefrom.

The information included in this Background section of the specification, including any references cited herein and any description or discussion thereof, is included for technical reference purposes only and is not to be regarded subject matter by which the scope of the invention is to be bound.

### SUMMARY

The present application discloses one or more of the features recited in the appended claims and/or the following features which alone or in any combination, may comprise patentable subject matter.

Present embodiments relate to an active insulated container and in some embodiments an active insulated container which is to be used in a vehicle. The active insulated container comprises an air intake and exhaust system for the thermal engines to exchange heat with air moving through the intake and exhaust system and remove heat from the active insulated container. Present embodiments provide structure and method of providing a pressurized system to eliminate, or at least reduce the possibility, of intaking water through the active insulated container air intake, even when the active insulated container is mounted below the fording line or within the fording depth.

According to some embodiments, an active insulated container comprises a housing comprising a base and one or more walls extending upwardly from the base, upper ends of the one or more walls defining an opening for access to an interior of the housing. A lid is disposed at the opening, the lid being movable to allow or limit access to the interior. A thermal engine comprising a compressor, a condenser, an evaporator, and at least one air mover, the thermal engine disposed in a thermal engine enclosure. A first duct and a second duct, the first duct configured to allow airflow from outside the housing to the thermal engine, and the second duct configured to allow airflow to exhaust from the thermal engine. An inlet of the first duct and an outlet of the second duct being disposed at a lower elevation of the housing, wherein air within the ducts and the thermal engine enclosure is compressed when water rises through the inlet and the outlet of the ducts.

In some embodiments, the active insulated container may further comprise a second air mover, wherein the first air mover pulls air into the first duct to the thermal engine and the second air mover moves air from the thermal engine.

In some embodiments, the first duct may have an intake end and the second duct having an exhaust end that are located adjacent to one another.

In some embodiments, the intake end of the first duct and the exhaust end of the second duct being spaced apart at the intake end and the exhaust end to prevent recirculating warm exhaust air through the inlet of the first duct back into the housing.

In some embodiments the intake end of the first duct and the exhaust end of the second duct may be at a substantially same elevation and further comprising at least one wall therebetween.

In some embodiments, the housing may comprise an exterior wall with an interior liner therein which define a thermal engine enclosure having one opening for the first duct and a second opening for the second duct.

In some embodiments, the active insulated container may further comprise a thermal engine enclosure between the exterior wall and the interior liner.

In some embodiments, the active insulated container may be configured to be mounted below a fording line of a vehicle.

In some embodiments, the exterior wall may have a clamshell configuration.

In some embodiments, the first duct and the second duct may be disposed between the exterior wall and the interior liner.

In some embodiments, a vehicle comprises a fording line of the vehicle, an active insulated container configured to be installed in the vehicle at a level below the fording line, the active insulated container having a housing comprising a base and a plurality of walls extending from the base, the plurality of walls defined by an exterior wall and a liner, and forming a thermal engine enclosure therebetween, upper ends of the plurality of walls defining an opening for access to an interior of the housing, a lid disposed at the opening, which opens and closes to allow or limit access to the interior. A thermal engine includes a compressor, a condenser, an evaporator, and at least one air mover, the thermal engine disposed in the thermal engine enclosure, a first duct and a second duct, the first duct configured to allow airflow from outside the housing to the thermal engine enclosure, and the second duct configured to allow airflow to exhaust from the thermal engine enclosure. An inlet of the first duct and an outlet of the second duct being disposed at a lower elevation of the housing, and each of the first duct and the second duct extending upwardly turning and extending downwardly such that air pressure in the thermal engine enclosure is higher than the pressure of incoming water in the first and second ducts, preventing water from entering through said first and second ducts.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. All of the above outlined features are to be understood as exemplary only and many more features and objectives of the various embodiments may be gleaned from the disclosure herein. Therefore, no limiting interpretation of this summary is to be understood without further reading of the entire specification, claims and drawings, included herewith. A more extensive presentation of features, details, utilities, and advantages of the present invention is provided in the following written description of various embodiments of the invention, illustrated in the accompanying drawings, and defined in the appended claims.

### BRIEF DESCRIPTION OF THE DRAWINGS

In order that the embodiments may be better understood, embodiments of an active insulated container will now be described by way of examples. These embodiments are not to limit the scope of the claims as other embodiments of a vehicle active insulated container will become apparent to one having ordinary skill in the art upon reading the instant description. Non-limiting examples of the present embodiments are shown in figures wherein:

FIG. 1 is a perspective view of an example vehicle;

FIGS. 2A and 2B are perspective views of an example active insulated container wherein 2B includes a section showing the duct assembly, according to some embodiments;

FIG. 3 is a schematic view of an example refrigeration circuit, according to some embodiments;

FIG. 4 is a side schematic view of the vehicle active insulated container, according to some embodiments;

FIG. 5 is a schematic side view showing the airflow through the thermal engine enclosure of the vehicle active insulated container of FIG. 5, according to some embodiments; and,

FIG. 6 is an exploded perspective view of an active insulated container, according to some embodiments.

### DETAILED DESCRIPTION

It is to be understood that a vehicle active insulated container is not limited in its application to the details of construction and the arrangement of components set forth in the following description or illustrated in the drawings. The described embodiments are capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings. In addition, the terms “connected” and “coupled” and variations thereof are not restricted to physical or mechanical connections or couplings.

Reference throughout this specification to “one embodiment”, “some embodiments” or “an embodiment” means that a particular feature, structure or characteristic described in connection with the embodiment is included in at least one embodiment of the present invention. Thus, appearances of the phrases “in one embodiment”, “in some embodiments” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

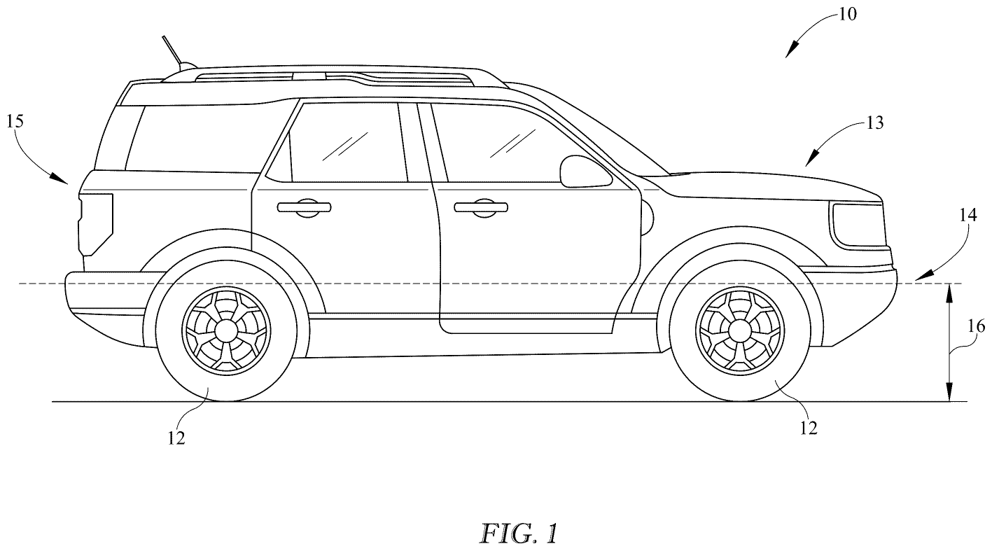

Referring now in detail to the drawings, wherein like numerals indicate like elements throughout several views, there are shown in FIGS. 1-6, embodiments of vehicle active insulated container are provided, which has a thermal engine to provide an active cooling or heating system that is electrically driven by the vehicle, for example by battery, combustion engine alternator, solar panel, generator, or combination, in some non-limiting embodiments. The vehicle active insulated container may comprise an air intake and an air outlet which move air across a thermal engine for heat exchange and removal of heat. The geometry of the air intake and air outlet eliminate, or at least greatly reduce the likelihood, that the water which may be present at or above the fording line, or within the fording depth, is drawn into the active insulated container air intake. This precludes flooding of the thermal engine enclosure or compartment with the thermal engine.

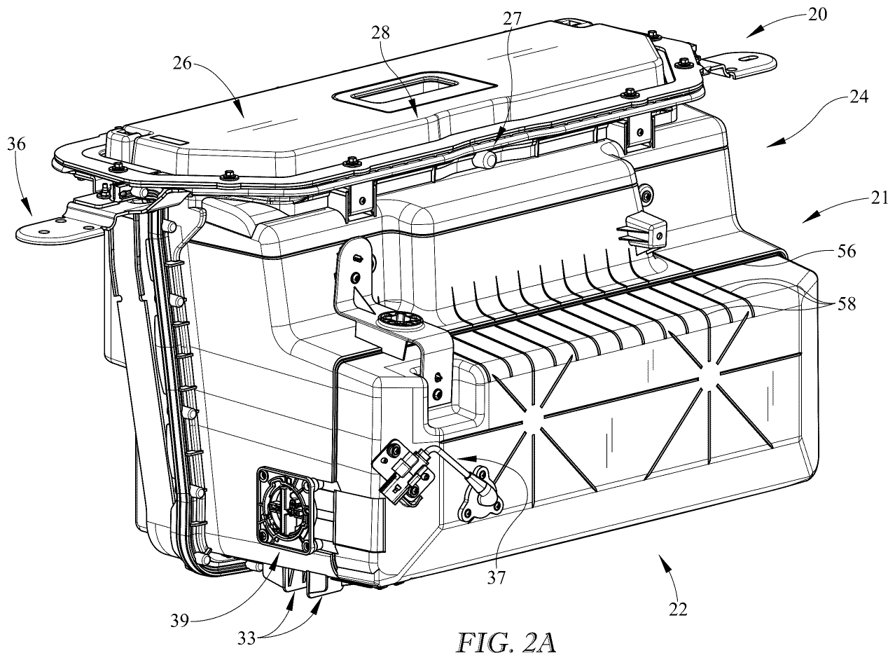

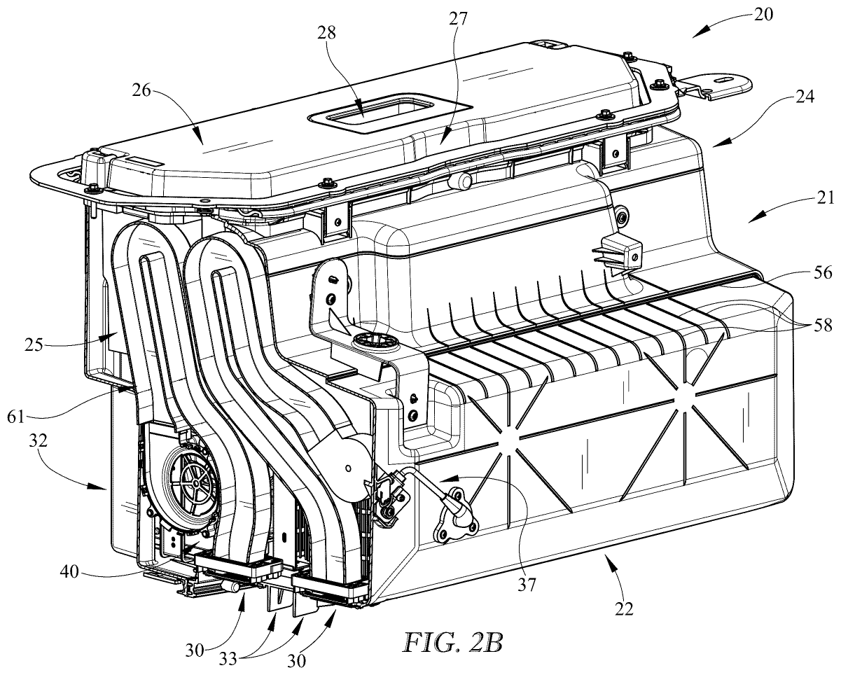

Referring now to FIG. 1, a side/perspective view of a vehicle 10 is shown. The vehicle 10 may comprise a plurality of tires 12 and a fording line 14 at which standing water may begin to damage the vehicle 10 is provided. In this view the difference between the contact point with the ground and the fording line 14 is the fording depth 16. The fording line 14 is generally defined at the height 16 of the vehicle at which water may begin to enter the vehicle and cause damage to the vehicle. In some conditions, it may occur that the vehicle 10 is driven through, or otherwise encounters water, at a level of or higher than the fording line 14. If an air intake for an active insulated container is located below this fording line 14, then water intrusion to components of an active insulated container 20 (FIG. 2) may be capable in this high water condition.

Additionally, while a smaller personal vehicle is vehicle is shown, other types of vehicles are within the scope of the instant teaching. For example, the vehicle 10 may be a coupe, sedan, truck, SUV, van, recreational vehicle, marine craft, or other where water intrusion into an area where the active insulated container 20 may be located. Further, the active insulated container 20 may be located in a trunk, frunk, cargo storage area within the vehicle, or exterior to the cabin, such as for example in the bed of a truck or an exterior storage area of a recreational vehicle or marine craft.

The vehicle 10 shown may comprise a frunk compartment 13, and/or a trunk or storage compartment 15. As the need to use space most efficiently increases with the need for overall vehicle efficiency, either of these compartments may comprise the active insulated container 20. In some embodiments, the active insulated container 20 may be located in other locations in the depicted vehicle or in other types of vehicles. Additionally, the active insulated container, air conditioner, or at least the air intake for these devices may be located at an elevation that is below the fording line 14, or within the fording depth 16. Thus, a concern becomes eliminating the likelihood of water intrusion into the active insulated container air intake when water is above the fording line 14 of the vehicle. For purpose of ease of description, the remainder of this disclosure will refer to active insulated container generally, but should be understood to include an air conditioner within the scope of the teaching, which likewise cools an enclosed space.

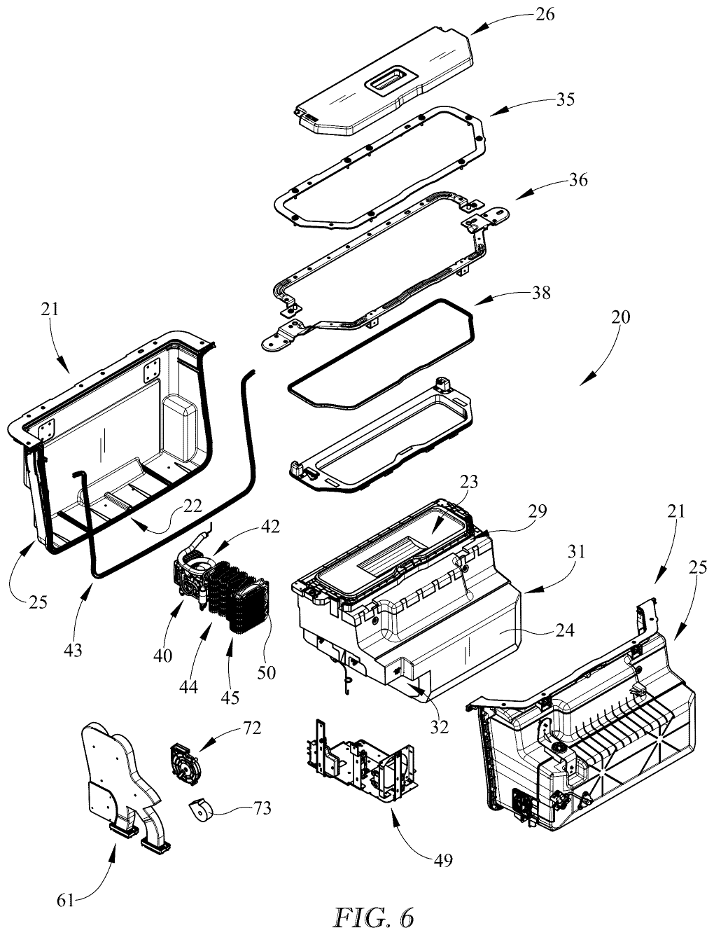

Referring now to FIGS. 2A and 2B, an assembled perspective view of an example vehicle active insulated container 20 is shown and described in combination with FIG. 6, which depicts an exploded perspective view. The vehicle active insulated container 20 comprises a housing 21 having a base 22 and a lid 26. The housing 21 has a base 22 and one or more walls 24 extending from the base 22. The base 22 and the one or more active insulated container walls 24 may be of various shapes to define an enclosed space 23 wherein food or drink may be stored at a desired temperature. The housing 21 may be a single structure or may comprise two or more structures which are fastened together during assembly. The instant embodiment housing 21, for example and without limitation, comprises a two piece structure with a seam that extends vertically along the sides, and across the bottom. The seam may comprise a seal 43 (FIG. 6) to provide a watertight and airtight connection. The active insulated container walls 24 may be insulated, by use of an insulating material about the container. In some embodiments, the active insulated container walls 24 and base 22 may be formed by an exterior wall 25 and may comprise an interior liner 29 (FIG. 6), wherein an insulation 31, for example foam disposed on the exterior of the interior liner 29 is located between the exterior wall 25 and the interior liner 29. In such embodiment, the enclosed space 23 may be defined within the interior liner 29. Further, in some embodiments, the exterior wall 25 and/or the interior liner 29 may be formed of a single structure or two or more structures. For example, as depicted, the exterior walls 25 may be formed of a first structure and a second structure which, when connected together, define a cavity and enclose the liner 29 and a thermal engine enclosure or compartment 32. For example, the exterior walls 25 form the thermal enclosure 32 and provide position for placement of the interior liner 29 therein, adjacent to the thermal engine enclosure 32. Also shown on the exterior of the housing 21 is a service port 39. The service port 39 may be sealed closed but also may be opened to access the thermal engine 40 for cleaning. For example, dirt and debris may be blown or vacuumed from this area to maintain operating efficiency of the heat exchanger condenser 44, for example.

In comparison of FIGS. 2A and 2B, the former shows the exterior walls 25 of one embodiment completely. The latter shows a section cut to reveal the interior of the housing 21 wherein the duct assembly 61 is shown with the thermal engine 40 behind. The duct assembly 61 and the thermal engine 40 are located with the exterior walls and within the thermal engine enclosure 32, and further external of the interior liner 29.

Also shown on the exterior of the exterior walls 25 are a plurality of grooves 56, 58. The grooves 56, 58 are shown in the embodiment as generally linear and create deformation or crumple zones in the exterior walls 25. These crumple zones allow for energy absorption in the event of a vehicle crash. The grooves 56, 58 may also be intersecting and may extend in one or more directions.

Shown at the top of the active insulated container 20 is a lid 26. The lid 26 may be pivotally connected to the one or more walls 24 so that the lid 26 may be opened and closed. In order to access the interior of the active insulated container 20, the lid 26 may be opened. When access is no longer needed, the lid 26 may be moved to a closed position. In other embodiments, the lid 26 may comprise one or more closures allowing the lid to be removed and then reconnected and/or locked in the closed position. In some embodiments, the lid 26 may be pivotally or hingedly connected to the lower portion of the container 20. The lid may be removable. In some embodiments, the lid 26 may have a combination of pivotal movement and removability for example by a hinge pin which is rotatable with the lid 26 and removable through a slot in the hinge. The lid 26 may also comprise a closure 27 to retain the lid 26 in the closed position. For example, the closure 27 may comprise a catch, latch, hook-and-loop, or other selectively releasable mechanism to lock or unlock the lid 26. In some embodiments, the lid 26 may comprise magnets which retain the lid 26 in a closed position. The lid 26 may comprise magnets of a first polarity and the opposed portion of the container 20 may comprise magnets of the opposite polarity, to retain the lid 26 in the closed position. The lid 26 may further comprise a finger grab 28 which is a depression that the user may grasp to open the lid 26. The finger grab 28 may be another structure which is clear to a user to grasp in order to open the lid 26. Further, while the lid 26 is shown to open along an upper surface of the active insulated container 20, other embodiments may provide a more door-like structure wherein the access is provided in a surface or area other than the top of the active insulated container 20.

The lid 26 may comprise a trim 35 which surrounds the lid 26 when the lid 26 is in a closed position. Below the trim 35 is a bracket that connects to the exterior of the active insulated container 20 and may also connect to the vehicle to retain the active insulated container 20 in position. The bracket 36 may be a single structure or may be a multi-piece structure as shown. Beneath the bracket 36 is a seal 38 which is retained in position which seals the upper portion of the active insulated container 20 when the lid 26 is closed.

The figures depicts the exterior wall 25 and a thermal engine 40 disposed between the exterior wall 25 and the interior liner 29. A thermal engine enclosure 32 is defined between the exterior wall 25 and the interior liner 29 wherein the thermal engine 40 may be located. The active insulated container exterior wall 25 may have one or more openings 30 to allow air entry and exit. The opening 30 allows for air movement through the thermal engine 40 for heat exchange. For example, in some embodiments there may be one or more openings for the inlet air and one or more openings for the outlet or exhaust air. The openings 30 may be covered with a screen or other mesh material to block environmental contaminants (ex. dirt, debris, leaves, bugs, or critters) from entering the openings and moving into the ducts 62, 64. Additionally, walls 33 may be positioned between the openings 30 to limit cross-flow or interaction between intake/inlet and exhaust airflows.

As shown in FIG. 6, the interior liner 29 may be formed with an overhanging area that creates a clearance or space for positioning of the thermal engine 40. The thermal engine enclosure 32 is formed by the exterior walls 25 of the housing 21 and the space created by the interior liner 29. A bracket 49 may be positioned beneath the thermal engine 40 for support and to connect the thermal engine 40 to the base 22 of the housing 21.

Also shown on the front surface of the container 20 is an electrical connector 37. The connector 37 provides electrical communication with the vehicle for powering the thermal engine 40. A wire or cable is shown extending through a wall of the housing 21.

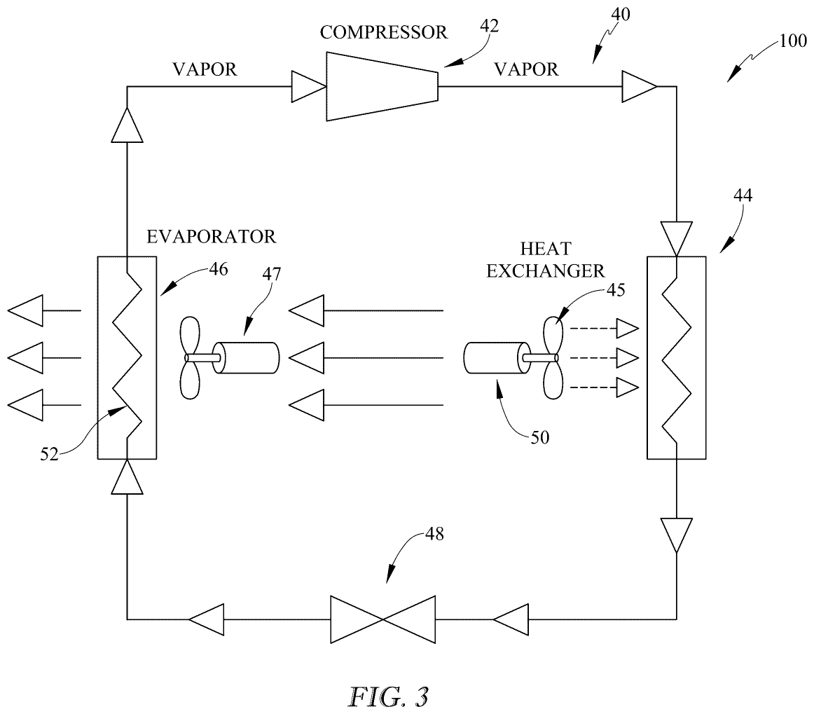

Referring now to FIG. 3, a schematic view of an example refrigeration circuit is shown having a plurality of components defining one exemplary thermal engine 40 used with an example active insulated container, or for example an air conditioning system 100. The term thermal engine may comprise a compression system, thermoelectric system, a heat pump, or an active heater and may provide cooling or heat for the active insulated container 20. In some embodiments, for example, the thermal engine 40 may comprise components that perform the conditioning of air, such as without limitation, a compressor 42, heat exchanger condenser 44, evaporator 46, and/or expansion device 48. Other components and devices may be utilized, and for example may include reversing valves for heat pump functionality. The air conditioning system 100 is shown in a schematic view for ease of discussion.

As depicted, the compressor 42 compresses a refrigerant, which passes from the compressor 42 through the air conditioning system 100. The compressor 42 comprises a motor, which may be a part of the compressor structure or may be a separate component that connects to the compressor 42. The motor is not shown but is generally represented and discussed as a portion of the compressor 42 throughout the specification. In the circuit, the compressed refrigerant next passes through a heat exchanger condenser 44, such as a condenser, which cools the vapor form refrigerant some amount and changes form to a liquid. The heat exchanger condenser 44 which may be in the form of a condenser utilizing air cooling heat exchange with atmosphere, or in other embodiments may be liquid cooled condenser which exchanges heat with a closed loop liquid. The heat exchanger condenser 44, when in the condenser form may comprise an air mover or air moving device 45, for example a fan, having a motor 50 to remove heat from the vapor and/or liquid passing through the coil. Alternatively, when in the form of a liquid cooled condenser, the heat exchanger condenser 44 may provide a coil-in-coil or a fin-and-coil heat exchange design in fluid connection with a pump movement of a closed loop liquid.

Next, the refrigerant reaches an expansion device 48, for example an expansion valve or capillary tube, which reduces pressure of the partially cooled refrigerant, further cooling the refrigerant before the refrigerant passes through an evaporator 46. The expansion device 48 may meter the refrigerant that is injected into the evaporator 46. The evaporator 46 may, in some embodiments, comprise a conductive or convective heat transfer, as will be understood by one skilled in the art. For example, the evaporator 46 may extend within the insulation 31 and against or within the interior liner 29 (FIG. 6) to provide heat transfer within the enclosed space 23 (FIG. 6).

The evaporator 46 may comprise one or more coils or tubes which extend inside the active insulated container 20. In some embodiments, the evaporator 46 may be located between the liner 29 and the exterior wall 25. In some examples, the coils 52 of the evaporator 46 may be located in the base and/or the one or more walls 24, or both of the liner 29. The cold temperature of the evaporator 46 removes heat from the enclosed space 23 of the active insulated container 20, within the liner 29. The evaporator 46 may comprise tube(s), fin(s), plate(s), or combinations to exchange heat with the interior of the active insulated container 20. In some embodiments, the evaporator 46 may in some embodiments include an optional air mover or air moving device 47 to move air across the evaporator fins.

After passing through the evaporator 46, the refrigerant returns to the compressor 42 for the compression to pass through the cycle again. The refrigerant may be of various types. For example, some refrigerants which may be utilized include hydrofluorocarbons (HFCs), such as R-410A, HCFCs such as R-22, HFCs R-134a, R600a, R1234yf, and/or R1234e. Still further, newer refrigerants may include supercritical carbon dioxide, known as R-744, R-470a and R466a. These have similar efficiencies compared to existing CFC and HFC based compounds and have lower global warming potential. These are merely examples however as other refrigerants may be used.

The schematic view 100 is a simple compression cycle and other features and functions may be utilized. For example, additional conduit lines of further complexity may be utilized to provide the desired cooling. As previously mentioned, a reversing valve may be added to provide heat pump function. The schematic view, therefore, is merely exemplary for depicting the general refrigerant compression cooling cycle and should not be considered limiting, as other embodiments are possible. Further however, the refrigeration cycle is merely one example and other components and variations are possible. For example, in some alternative embodiments, a thermoelectric system may be used to remove heat from the active insulated container to provide cooling to the active insulated container.

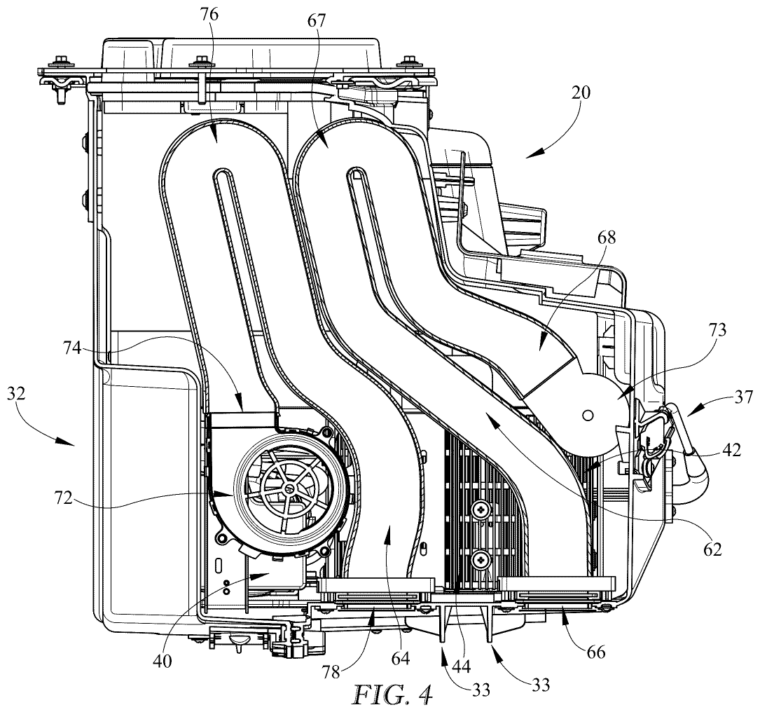

Referring now to FIG. 4, a side schematic view of the vehicle active insulated container 20 is depicted. The view depicts the air ducts 62, 64 with some of the thermal engine 40 partially shown behind. The air ducts 62, 64 may be one or more structures. For example, a single duct assembly 61 (FIG. 6) is shown comprising the air ducts 62, 64 in FIG. 6. The duct assembly 61 may be connected to the interior liner 29 for example. The thermal engine 40 comprises an intake duct 62 and an exhaust duct 64. The intake duct 62 has a lower intake duct inlet 66 and extends upwardly from the intake duct inlet 66 at the bottom of the intake duct 62. The intake duct 62 has an upper bend 67 where the airflow direction changes from upward to downward. The intake duct 62 extends downwardly some distance that in some embodiments is about halfway downwardly into the height of the thermal engine enclosure 32. The intake duct 62 is shown with the optional air mover 73, for example without limitation, a fan or blower at an outlet of duct 62. The air mover 73 may be used to increase airflow across the thermal engine 40.

The outlet 68 is located near a condenser fan 45 (FIG. 6). The condenser fan 45 provides air to the heat exchanger condenser 44. The air from the intake duct 62 increases in temperature due to the heat gain from the heat exchanger condenser 44.

The thermal engine enclosure 32 may also comprise an exhaust air mover or air moving device 72, for example and without limitation fan or blower or other device which moves air. The exhaust air mover 72 may pull the air that has engaged with the heat exchanger condenser 44 into the exhaust air mover 72 and push such exhaust air through the exhaust duct 64. The exhaust duct 64 has, in some embodiments, an exhaust inlet 74 at the exhaust air mover 72 and may extend upwardly therefrom. The exhaust air mover 72 then pushes the exhaust airflow from an upwardly moving direction to a downwardly moving direction. An optional air mover 73 may be utilized on the intake side to aid in the pulling air into the thermal engine compartment 32 and aid in air change within the thermal engine compartment 32 wherein the thermal engine 40 is operating.

According to some embodiments, outlet 68 of the intake duct 62 and the exhaust inlet 74 of the exhaust duct 64 are at higher elevations than the other ends of the respective ducts 62, 64. Further, the outlet 68 of the intake duct 62 and the exhaust inlet 74 of the exhaust duct 64 have a lower elevation than the beginning tangent of the each respective bend 67, 76 of each duct 62, 64. This forms an air trap in each duct 62, 64.

As shown in the figure, the intake duct 62 and the exhaust duct 64 may be closely positioned, for example adjacent to one another. The close positioning allows for placement within the thermal engine enclosure 32. However, the inlet 66 and outlet 78 are separated so that the inlet air does not mix within the outlet or exhaust air. Additionally for example, the one or more walls 33 may be used to keep the air separated.

Further, while two air moving devices 45, 72 are shown, it may be that a single air mover is used in order to draw fresh air through the intake duct 62 and push exhaust air from the exhaust duct 64. Additionally, the additional air mover 73 (FIG. 4) may optionally be used to further assist with movement of air in and out of the thermal engine compartment 32.

The heat exchanger condenser 44 is shown adjacent to the condenser air mover 45. Also, within the thermal engine enclosure 32, the compressor 42 is shown.

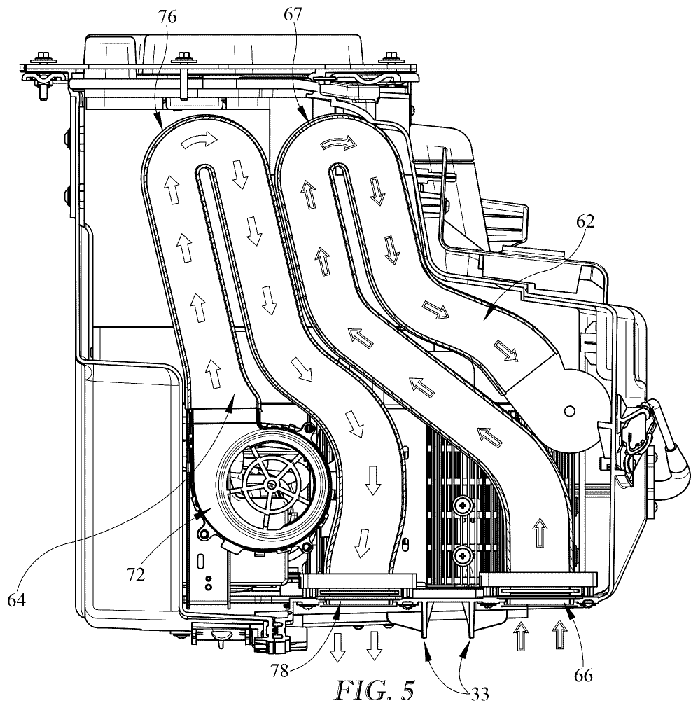

Referring to FIGS. 5 and 6, a schematic side view and exploded perspective view are shown. FIG. 5 represents the airflow through the thermal engine enclosure 32 and is described in addition to FIG. 6 for ease of understanding. As depicted, fresh air is drawn into the intake duct inlet 66 of intake duct 62 and moves upwardly. The fresh air then turns downwardly moving down until it exits the outlet 68. Next the fresh air is drawn through the condenser fan 45 and then push through the heat exchanger condenser 44. At this point the air gains heat energy from the heat exchanger condenser 44 and for purpose of this description becomes exhaust air.

The exhaust air is next drawn through the exhaust air mover, for example blower or fan, 72 and moves upwardly through the exhaust inlet 74 of the exhaust duct 64. The exhaust air turns downwardly within the exhaust duct 64. The exhaust duct 64 has an exhaust outlet 78 at a location adjacent to the intake duct inlet 66.

In operation, and during some conditions, the intake duct 62 and exhaust duct 64 may have lower ends (inlet 66, and outlet 78) at a level below the fording line 14 such that water may be at or above the intake duct inlet 66 and the outlet 78. At such water level, the water could enter the intake duct 62 and exhaust duct 64 and move into the thermal engine enclosure 32. The thermal engine 40 needs to be protected from water entering the thermal engine enclosure 32 between the interior liner 29 and exterior wall 25, when the active insulated container 20 is temporarily submerged in water at or above the vehicle fording line 14. Stated alternatively, there is a need to preclude drawing water into this area and potentially damaging the components of the thermal engine. In instant embodiments, this protection is achieved by compressing air in the thermal engine enclosure 32 and the ducts 62, 64. The compression creates a force that stops or impedes movement of water into the ducts 62, 64 when the water level is at or above the fording line 14.

Each of the intake duct 62 and the exhaust duct 64 have an inverted U-shaped, or bend 67, 76, which create traps. The trap precludes water entry past or beyond the upper ends of the intake duct 62 and exhaust duct 64. Further, when the active insulated container 20 is submerged in water at or above the vehicle fording line 14, water will enter the air ducts 62, 64 through the intake duct inlet 66 and exhaust outlet 78. Due to the space between the interior liner 29 and exterior wall 25 being sealed, the water, entering the air ducts 62, 64, compresses the air between the liner 29 and exterior wall 25 around the thermal engine 40, creating an opposing pressure, stopping the water raising in the upwardly turning air ducts, preventing it from entering the thermal engine enclosure 32 or space between the interior liner 29 and exterior wall 25. As a result water is therefore precluded, by the compressed air pocket/bubble, from entry to the sealed thermal engine enclosure 32. Stated differently, the air pressure opposing the water within the duct system results in equalized displacement down to specific atmospheric conditions. The compressed volume of air works against the incoming water in the ducts 62, 64, and in operation will keep incoming water at or below the upper level of the U-bends in the ducts 62, 64. The configuration allows operation when water is not present without having to add check valves or other such hardware to preclude water entry. The volume of the ducts 62, 64 and thermal engine enclosure 32 play a role in the amount of compression force to counteract the inbound water. The smaller the thermal enclosure and duct volume, the less air to be compressed. The less the amount of air, the better the compression that occurs.

Additionally, the housing 21 may be sealed to be water tight. If a vehicle drives into high water or become submerged, the assembly is watertight including the various structures that pass through the housing 21, for example the lid 26, and the electrical connector 37.

In some embodiments, the system may additionally comprise a water sensor or float to shut off the air movers when the presence of water is detected. Such shut off may be desirable to prevent damage to the thermal engine if full submersion occurs, so that the components are not damaged in such condition. In some embodiments, the thermal engine 40 or the thermal engine enclosure 32 may comprise an over-temperature protection sensor or mechanism. This over-temperature sensor or mechanism may shut down the thermal engine when the temperature reaches the critical limit, for example if during a high water condition, the cooling air supply is limited. Alternatively, or additionally, the system may comprise current monitoring to also shut down in the event of water entry at the intake and exhaust duct 62, 64.

While several inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the invent of embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

All definitions, as defined and used herein, should be understood to control over dictionary definitions, definitions in documents incorporated by reference, and/or ordinary meanings of the defined terms. The indefinite articles “a” and “an,” as used herein in the specification and in the claims, unless clearly indicated to the contrary, should be understood to mean “at least one.” The phrase “and/or,” as used herein in the specification and in the claims, should be understood to mean “either or both” of the elements so conjoined, i.e., elements that are conjunctively present in some cases and disjunctively present in other cases.

Multiple elements listed with “and/of” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/of” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of” “Consisting essentially of,” when used in the claims, shall have its ordinary meaning as used in the field of patent law.

Unless otherwise indicated, all numbers expressing quantities of ingredients, properties such as reaction conditions, and so forth used in the specification and claims are to be understood as being modified in all instances by the term “about”. Accordingly, unless indicated to the contrary, the numerical parameters set forth in this specification and claims are approximations that can vary depending upon the desired properties sought to be obtained by the presently-disclosed subject matter.

As used herein, the term “about,” when referring to a value or to an amount of mass, weight, time, volume, concentration or percentage is meant to encompass variations of in some embodiments ±20%, in some embodiments ±10%, in some embodiments ±5%, in some embodiments ±1%, in some embodiments ±0.5%, and in some embodiments ±0.1% from the specified amount, as such variations are appropriate to perform the disclosed method.

As used herein, ranges can be expressed as from “about” one particular value, and/or to “about” another particular value. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures.

Certain terminology is used in the following description for convenience only and is not limiting. The words “right,” “left,” “top,” and “bottom” designate directions in the drawings to which reference is made. The words “a” and “one” are defined as including one or more of the referenced item unless specifically stated otherwise. This terminology includes the words above specifically mentioned, derivatives thereof, and words of similar import. The phrase “at least one” followed by a list of two or more items, such as A, B, or C, means any individual one of A, B or C as well as any combination thereof.

The foregoing description of methods and embodiments has been presented for purposes of illustration. It is not intended to be exhaustive or to limit the invention to the precise steps and/or forms disclosed, and obviously many modifications and variations are possible in light of the above teaching. It is intended that the scope of the invention and all equivalents be defined by the claims appended hereto.

1. An active insulated container, comprising:
a housing comprising a base and one or more walls extending upwardly from said base;
upper ends of said one or more walls defining an opening for access to an interior of said housing;
a lid disposed at said opening, said lid being movable to allow or limit access to said interior;
a thermal engine comprising a compressor, a condenser, an evaporator, and at least one air mover, said thermal engine disposed in a thermal engine enclosure;
a first duct and a second duct, said first duct configured to allow airflow from outside said housing to said thermal engine, and said second duct configured to allow said airflow to exhaust from said thermal engine;
an inlet of said first duct and an outlet of said second duct being disposed at a lower elevation of said housing, wherein air within said first and second ducts and said thermal engine enclosure is compressed when water rises through said inlet and said outlet of said first and second ducts.

2. The active insulated container of claim 1, further comprising a second air mover wherein said at least one air mover pulls air into said first duct to said thermal engine and said second air mover moves air from said thermal engine.

3. The active insulated container of claim 1, said first duct having an intake end and said second duct having an exhaust end that are located adjacent to one another.

4. The active insulated container of claim 3, said intake end of said first duct and said exhaust end of said second duct being spaced apart at the intake end and the exhaust end to prevent recirculating warm exhaust air through the inlet of the first duct back into the housing.

5. The active insulated container of claim 4, said intake end of said first duct and said exhaust end of said second duct being at a substantially same elevation and further comprising at least one wall therebetween.

6. The active insulated container of claim 1, said housing comprising an exterior wall with an interior liner therein which define said thermal engine enclosure having one opening for said first duct and a second opening for said second duct.

7. The active insulated container of claim 6, further comprising said thermal engine enclosure between said exterior wall and said interior liner.

8. The active insulated container of claim 1, said active insulated container configured to be mounted below a fording line of a vehicle.

9. The active insulated container of claim 7 said exterior wall having a clamshell configuration.

10. The active insulated container of claim 7, said first duct and said second duct disposed between said exterior wall and said interior liner.

11. A vehicle, comprising:
a fording line of the vehicle;
an active insulated container configured to be installed in said vehicle at a level below said fording line;
said active insulated container having:
a housing comprising a base and a plurality of walls extending from said base, said plurality of walls defined by an exterior wall and a liner, and forming a thermal engine enclosure therebetween;
upper ends of said plurality of walls defining an opening for access to an interior of said housing;
a lid disposed at said opening, which opens and closes to allow or limit access to said interior;
a thermal engine including a compressor, a condenser, an evaporator, and at least one air mover, said thermal engine disposed in said thermal engine enclosure;
a first duct and a second duct, said first duct configured to allow airflow from outside said housing to said thermal engine enclosure, and said second duct configured to allow said airflow to exhaust from said thermal engine enclosure;
an inlet of said first duct and an outlet of said second duct being disposed at a lower elevation of said housing, and each of said first duct and said second duct extending upwardly turning and extending downwardly such that air pressure in said thermal engine enclosure is higher than the pressure of incoming water in said first and second ducts, preventing water from entering through said first and second ducts.
